(19) United States
(12) Patent Application Publication
(10) Pub. No.: US 2013/0078842 A1
(43) Pub. Date: Mar. 28, 2013

(54) Electrical Connector Assembly with Locking Mechanism

(71) Applicants: Chu-hsueh Lee, New Taipei City (TW); Wen-Hsien Lin, Keelung City (TW)

(72) Inventors: Chu-hsueh Lee, New Taipei City (TW); Wen-Hsien Lin, Keelung City (TW)

(73) Assignee: WIESON TECHNOLOGIES CO., LTD., New Taipei City (TW)

(21) Appl. No.: 13/241,222

(22) Filed: Sep. 23, 2011

(51) Int. Cl. H01R 13/627

(52) U.S. Cl. 439/352

(57) ABSTRACT

The present invention relates to an electrical connector assembly with locking mechanism, comprising: an electrical connector and an electrical plug. The electrical connector comprises: a connector main body, and a plurality of first terminals, wherein the electrical connector has a first surface with a first accommodating portion, and a terminal covering body being extendedly disposed on the bottom of the first accommodating portion, moreover, the terminal covering body has a first locking portion formed on the side surface thereof. The electrical plug comprises a locking mechanism. The locking mechanism can be locked with the first locking portion, and the electrical plug is connected steadily with the electrical connector.

### BACKGROUND OF THE INVENTION

1. Technical Field

The present invention relates to an electrical connector assembly with locking mechanism, and more particularly, to an improved electrical connector assembly having a first locking portion and a second locking portion in an electrical connector and an electrical plug thereof, respectively.

2. Description of Related Art

DIN connector is a kind of connector standardized by the German Institute for Standardization (Deutsches Institut Normung) and has been widely used in variation of applications until the present; generally, the DIN connector includes a plug and a connector that can be assembled with the each other.

Please refer to FIG. 1A to FIG. 1C, shown a front view, a side view and a stereo view of a conventional electrical connector assembly, respectively. As shown in FIG. 1A, a conventional electrical connector assembly includes an electrical connector P100, and the electrical connector P100 includes a dielectric member P110 and a first metal cover P120, wherein the dielectric member P110 is made of plastic and has a plurality of shelter tunnels P111 and three orienting grooves P112. As shown in FIG. 1B, the electrical connector P100 further includes a plurality of metal strips P130 deposed in the shelter tunnels P111. One end of the metal strips P130 extend out of the shelter tunnels P111 and forming a conductive end P131; then, the conductive end P131 are used to be connected electrically with any electrical unit. As shown in FIG. 1C, the conventional electrical connector assembly also includes a electrical plug P200, which includes a second metal cover P210 and a plurality of terminals P220, and three protruding members P211 are formed on the second metal cover P210.

When the electrical plug P200 is assembled with the electrical connector P100, the three protruding members P211 correspond to the three orienting grooves P112, respectively; also, the plurality of terminals P220 are inserted into the plurality of shelter tunnels P111 and contact with the metal strips P130, respectively, so as to make the electrical plug P200 electrically connect with the electrical connector P100. Moreover, the first metal cover P120 and the second metal cover P210 are configured to eliminate circuit noise.

So that, through above descriptions, it is able to know that the constituting elements and the structure thereof of the conventional electrical connector assembly, moreover, it can also find that conventional electrical connector assembly includes the drawbacks and the shortcomings as follows:
1. Break away easily: The factors, influence the electrical connector P100 being steadily fixed in the electrical plug P200 depend on the frictions between the three protruding members P211 and the three orienting grooves P112 as well as the plurality of terminals P220 and the plurality of shelter tunnels P111. However, the strength of the frictions may decay with time go through, therefore, the electrical connector P100 can break away from the electrical plug P200 so easily when slightly pulling the electrical connector P100 fixed in the electrical plug P200. Thus, that would cause some matters like transmission of information interrupted, or data losing.
2. Bad contact: When the plurality of terminals P220 are inserted into the plurality of shelter tunnels P111, some of the plurality of metal strips P130 suffer extrusion and deformation, or are extruded out of the shelter tunnels P111. Thus, the terminals P220 can not contact with the metal strips P130, and cause bad contact.

Accordingly, in view of the conventional electrical connector assembly still has shortcomings and drawbacks, the inventor of the present application has made great efforts to make inventive research thereon and eventually provided an electrical connector assembly with locking mechanism.

### BRIEF SUMMARY OF THE INVENTION

The primary objective of the present invention is to provide an electrical connector assembly with locking mechanism, in which, the first locking portion is locked with the second locking portion for making the electrical plug unable to be easily broken away from the electrical connector, moreover, the electrical plug can be easily pulled out from the electrical connector by way of pressing the pressing portion to release the fastening of the first locking portion and the second locking portion.

Another objective of the present invention is to provide an electrical connector assembly with locking mechanism, in which, the first terminals deposited in the first accommodating portion have two tongue plates, so that the second terminals can be steadily clamped after being inserted into the first accommodating portion, then the poor contact between the first terminal and the second terminals can be avoided.

Accordingly, to achieve the above objectives of the present invention, the inventor proposes an improved electrical connector assembly with locking mechanism, comprising: an electrical connector, comprising: a connector main body, a housing, a plurality of first terminals, and a cover, wherein the electrical connector has a first surface with a first accommodating portion and a second surface with a second accommodating portion, and a terminal covering body being extendedly disposed on the bottom of the first accommodating portion, moreover, the terminal covering body has a plurality of tunnels, and a first locking portion formed on the side surface thereof.

The housing is able to be plugged into the second accommodating portion for combining with the connector main body. The cover is configured to cover the connector main body and the housing.

Each of the first terminals has a first end with two tongue plates and a second end, and all the first ends pass through the plurality of tunnels, respectively. The second end passes through the housing and protrudes from one side of the housing for plugging into an external printed circuit board.

The electrical connector assembly with locking mechanism of the present invention also comprises an electrical plug, which is plugged into the first accommodating portion of the electrical connector for assembling with the electrical connector, the electrical plug comprising: a plug main body, a plurality of second terminals, and a locking mechanism, wherein the second terminals pass through the plug main body. The locking mechanism is deposed on one side of the plug main body and has a pressing portion and a second locking portion.

Wherein when the electrical plug is assembled with the electrical connector, the locking mechanism enters the first accommodating portion and locates on the side surface of the terminal covering body, meanwhile, the second locking portion of the locking mechanism is locked with the first locking portion on the side surface of the terminal covering body, and then the electrical plug is connected steadily with the electrical connector.

Wherein when the electrical plug is assembled with the electrical connector, the second terminals, enter into the tunnels respectively, and contact with the two tongue plates of the first terminals, such that the electrical plug is electrically connected with the electrical connector.

Wherein when a force is applied to the pressing portion, the second locking portion of the locking mechanism disconnecting from the first locking portion on the side of the terminal covering body, and then the electrical plug can be removed from the first accommodating portion easily.

### BRIEF DESCRIPTION OF THE SEVERAL VIEWS OF THE DRAWINGS

The invention as well as a preferred mode of use and advantages thereof will be best understood by referring to the following detailed description of an illustrative embodiment in conjunction with the accompanying drawings, wherein:

FIG. 1A is a front view of the conventional electrical connector assembly;

FIG. 1B is a side view of the conventional electrical connector assembly;

FIG. 1C is a stereo view of the conventional electrical connector assembly;

FIG. 2 is an exploded view of the electrical connector assembly with locking mechanism according to the present invention;

FIG. 3A is a front view of the connector main body according to the present invention;

FIG. 3B is a rear view of the connector main body according to the present invention;

FIG. 3C is a lateral cross sectional view of the connector main body according to the present invention;

FIG. 3D is a stereo view of the connector main body according to the present invention;

FIG. 4 is a stereo view of the first terminals according to present invention;

FIG. 5A is a front view of the cover according to the present invention;

FIG. 5B is a side view of the cover according to the present invention;

FIG. 6A is a front view of the electrical plug according to the present invention;

FIG. 6B is a vertical view of the electrical plug according to the present invention;

FIG. 7A and FIG. 7B are lateral cross sectional view of assembling diagrams of the electrical connector and the electrical plug according to the present invention; and

FIG. 8 is a stereo view of the electrical connector assembly with locking mechanism according to the present invention.

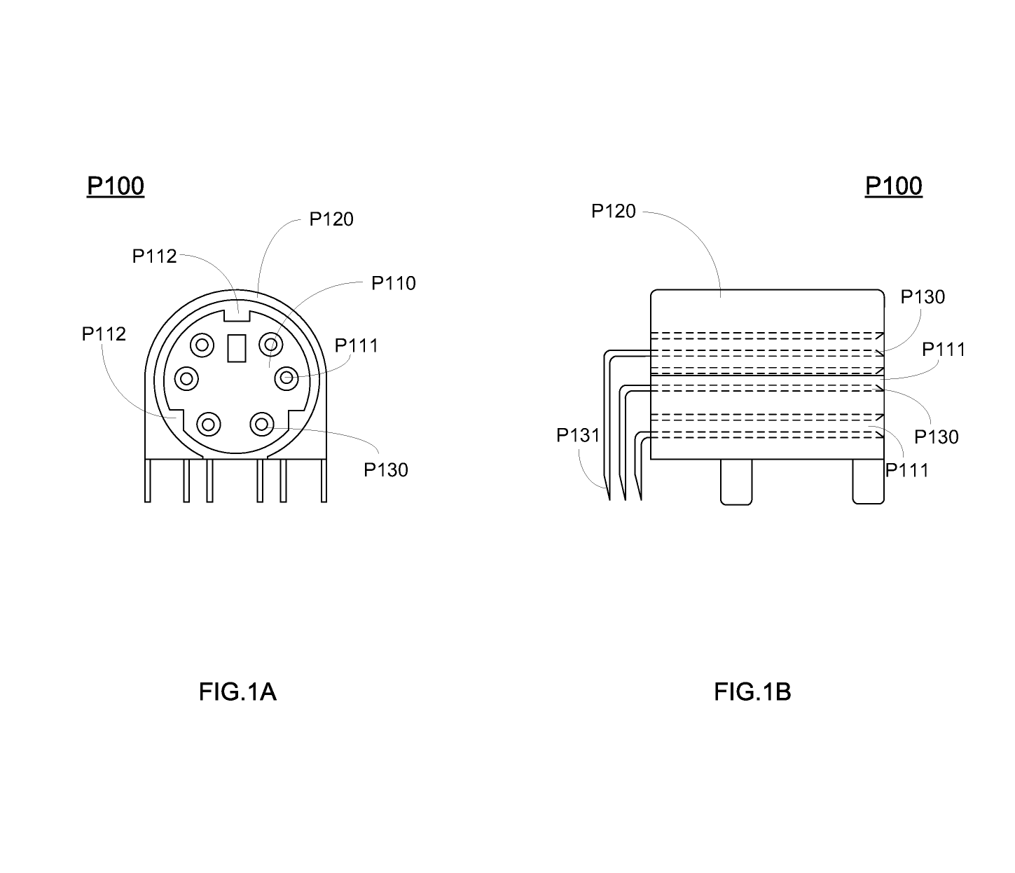

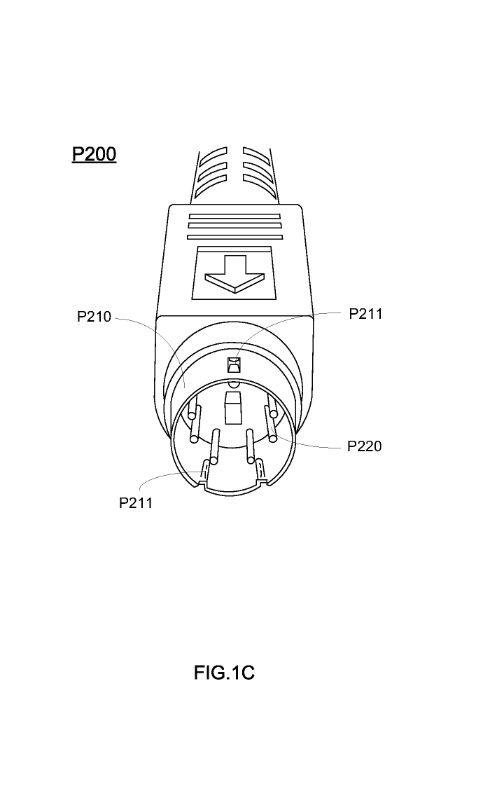

### DETAILED DESCRIPTION OF THE INVENTION

To more clearly describe an improved electrical connector assembly according to the present invention, embodiments of the present invention will be described in detail with reference to the attached drawings hereinafter.

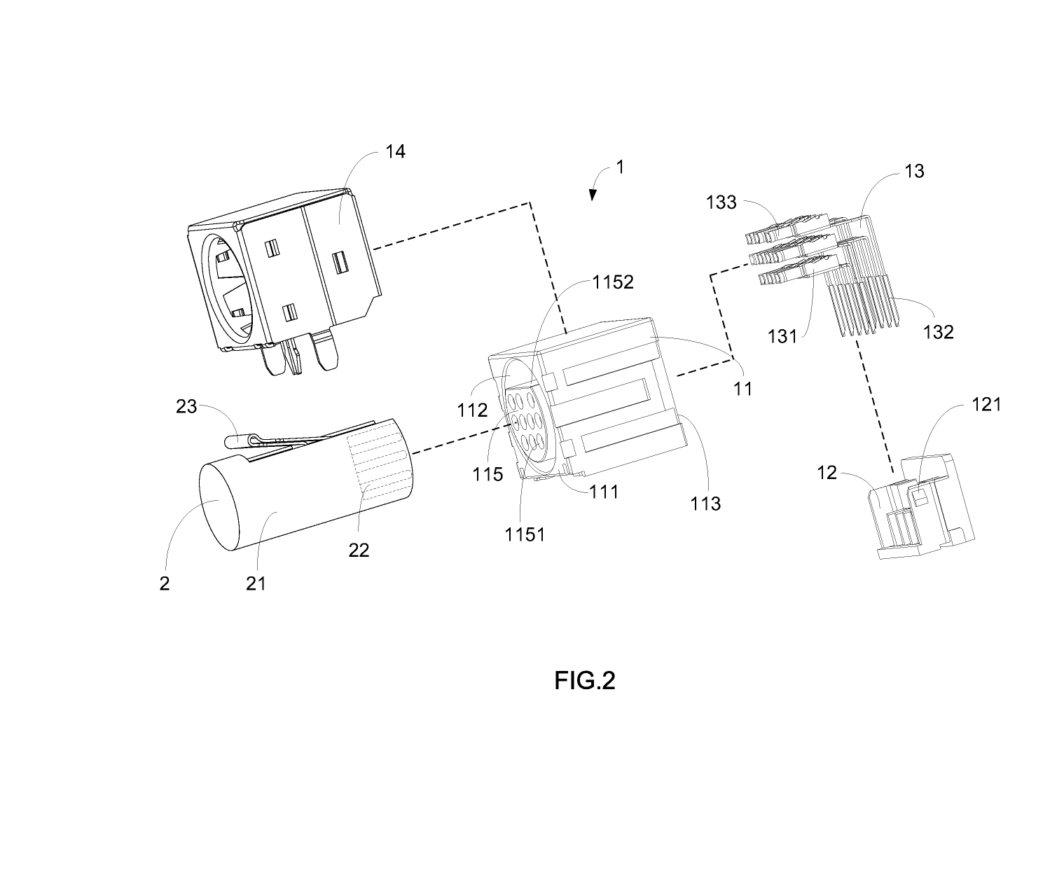

Please refer to FIG. 2, there is shown an exploded view of the electrical connector assembly with locking mechanism according to the present invention. As shown in FIG. 2, the electrical connector assembly with locking mechanism mainly includes an electrical connector 1 and an electrical plug 2, wherein the electrical connector 1 consists of a connector main body 11, a housing 12, a plurality of first terminals 13, and a cover 14. The connector main body 11 is made by a dielectric material has a first surface 111 with a first accommodating portion 112, and a terminal covering body 115 extendedly disposed on the bottom of the first accommodating portion 112. The terminal covering body 115 has a plurality of tunnels 1151 and a first locking portion 1152 formed on the side surface of the terminal covering body 115. The housing 12 is made by a dielectric material and plugged into the connector main body 11, in addition, the housing 12 has two second two second protruding blocks 121 formed on two opposite outer sides thereof. The first terminal 13 is made by an electric material and has a first end 131 with two tongue plates 133 and a second end 132, wherein the first ends 131 of the first terminals 13 respectively pass through the tunnels 1151, respectively. The second ends 132 of the first terminals 13 pass through the housing 12 and protrude from one side of the housing 12 for plugging into an external printed circuit board. Besides, the cover 14 is configured to cover the connector main body 11 and the housing 12.

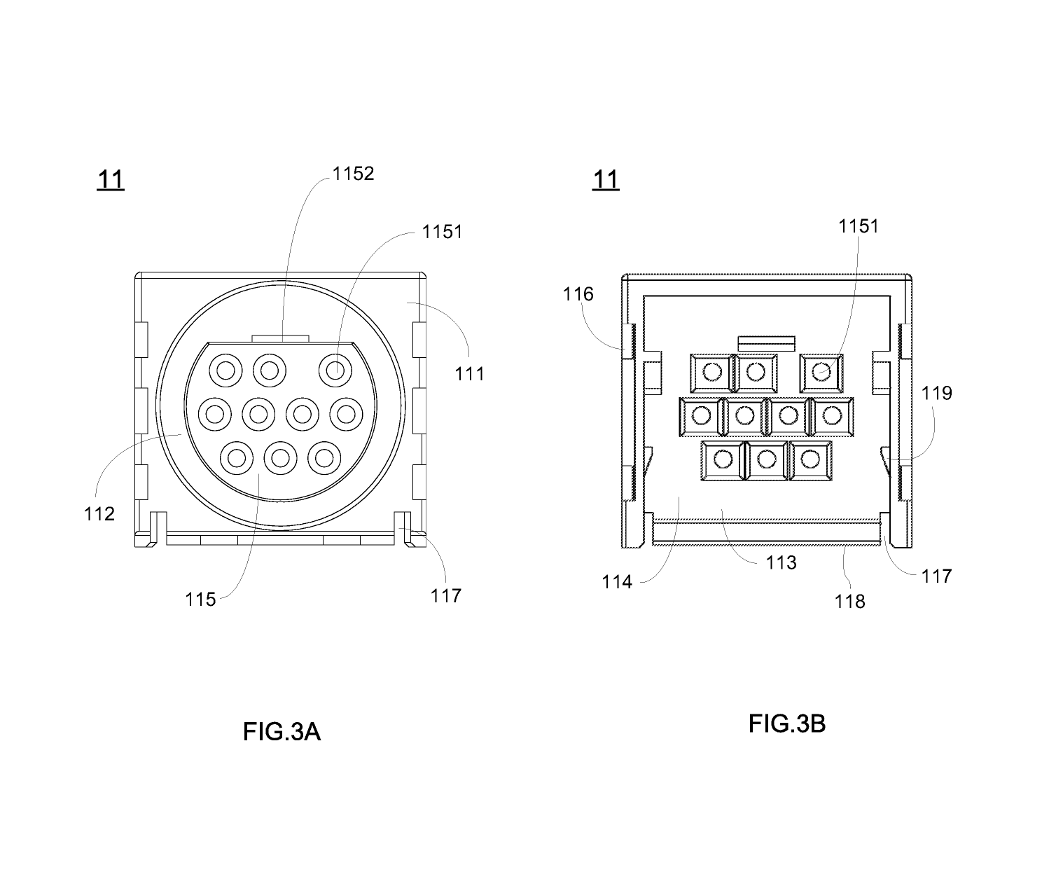

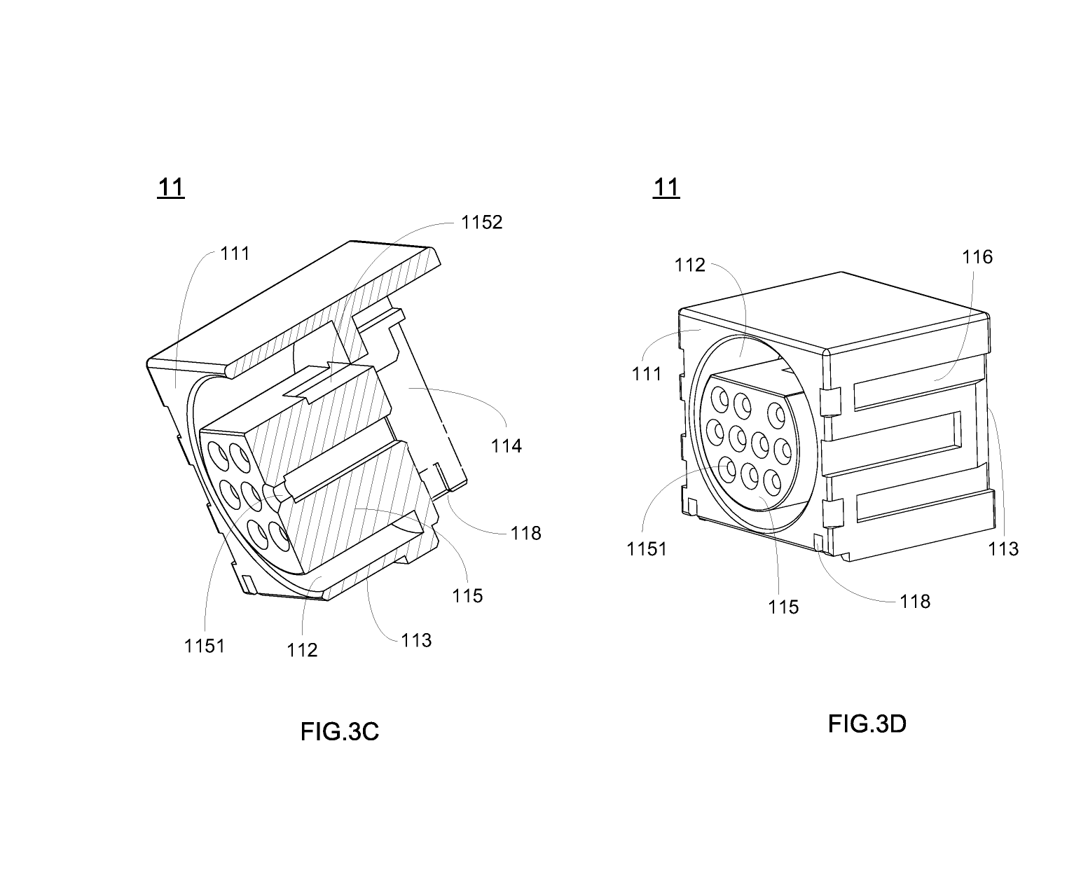

For more clearly describing the connector main body 11 of the electrical connector 1, please refer to FIGS. 3A, 3B, 3C and 3D, there are shown a front view, a rear view, a lateral cross sectional view, and a stereo view of the connector main body according to the present invention, respectively. As shown in FIGS. 3A to 3D, the connector main body 11 further has a second surface 113, a second accommodating portion 114, a plurality of first grooves 116, a plurality of second grooves 117, a second accommodating portion opening 118, and two first protruding blocks 119, wherein the second surface 113 is opposite to the first surface 111 and the second accommodating portion 114 is formed on the second surface 113. Moreover, the first grooves 116 are formed on the two sides surfaces of the connector main body 11, and the second grooves 117 are formed on the top surface and the bottom surface of the connector main body 11. The second accommodating portion opening 118 is formed on one side of the second accommodating portion, and the two first protruding blocks 119 are formed on the two opposite inner surfaces of the second accommodating portion, respectively.

Please refer to FIG. 2, FIG. 3A, FIG. 3B, FIG. 3C, and FIG. 3D again, when the housing 12 is inserted into the second accommodating portion 114 through the second accommodating portion opening 118, the second protruding blocks 121 are locked with the first protruding blocks 119, such that the housing 12 is solidly combined with the connector main body 11; therefore, the electrical connector assembly with locking mechanism according to present invention can be posited on an external printed circuit board through the second grooves 117.

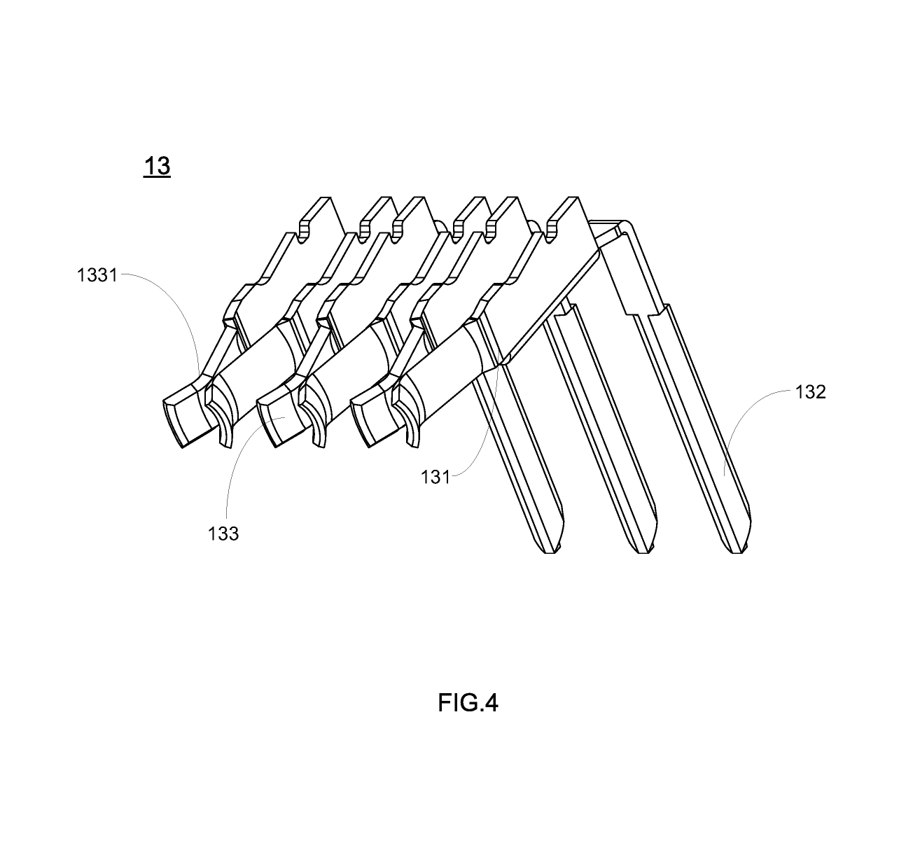

Please refer to FIG. 4, which illustrates a stereo view of the first terminals according to present invention. As shown in FIG. 4, the first terminal 13 is L-shaped and the cross section thereof is U-shaped. The two tongue plates 133 extend from one end of the first end 131 and have a bending 1331, respectively.

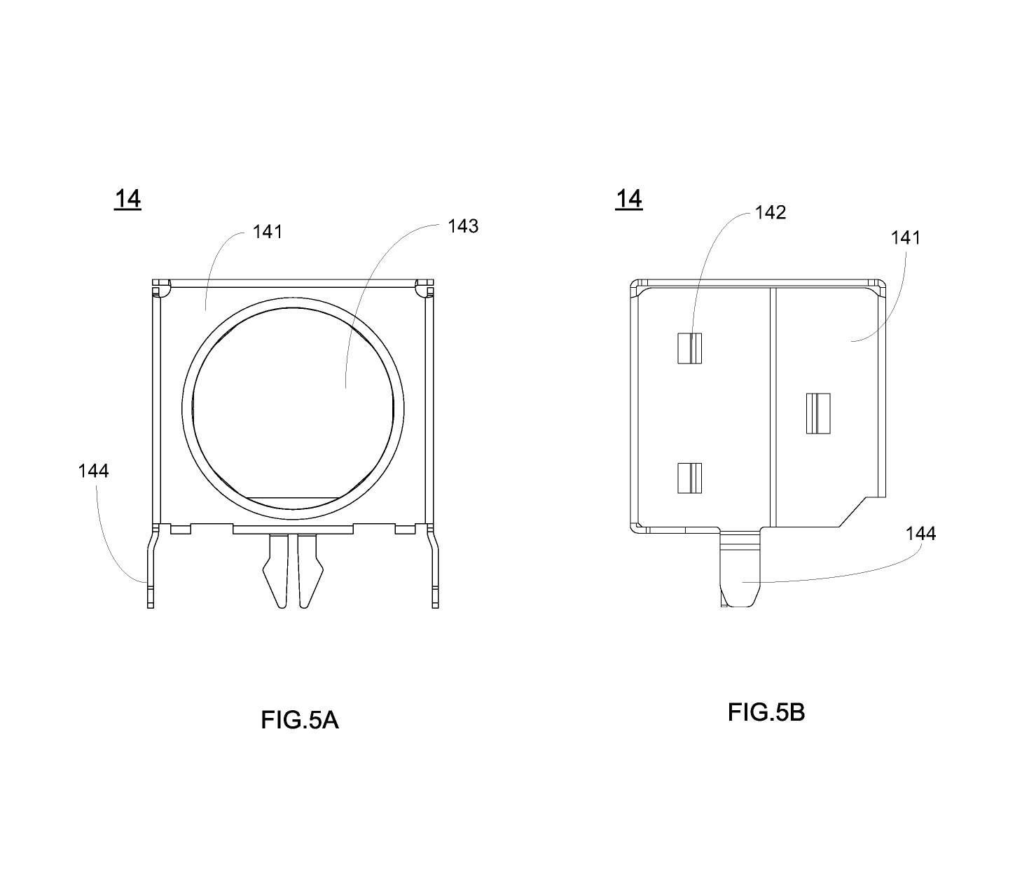

Please refer to FIG. 5A and FIG. 5B, there are shown a front view and a side view of the cover according to the present invention. As shown in FIG. 5A and FIG. 5B, the cover 14 is made by an electric material and includes: a cover main body 141, a plurality of positioning members 142, a cover opening 143, and at least one plugging member 144. Wherein the positioning members 142 are formed on the two opposite sides of the cover main body 141, the cover opening 143 is formed at the front surface of the cover main body 141, and the plugging member 144 is configured to plug into a hole of an external printed circuit board.

Please refer to FIG. 2, FIG. 3D, FIG. 5A, and FIG. 5B together, the positioning members 142 are corresponding to the first grooves 116 when the cover 14 is covered the connector main body; moreover, the cover opening 143 is corresponding to the first surface 111, thus the electrical plug 2 is able to assembling with the electrical connector 1 through the cover opening 143.

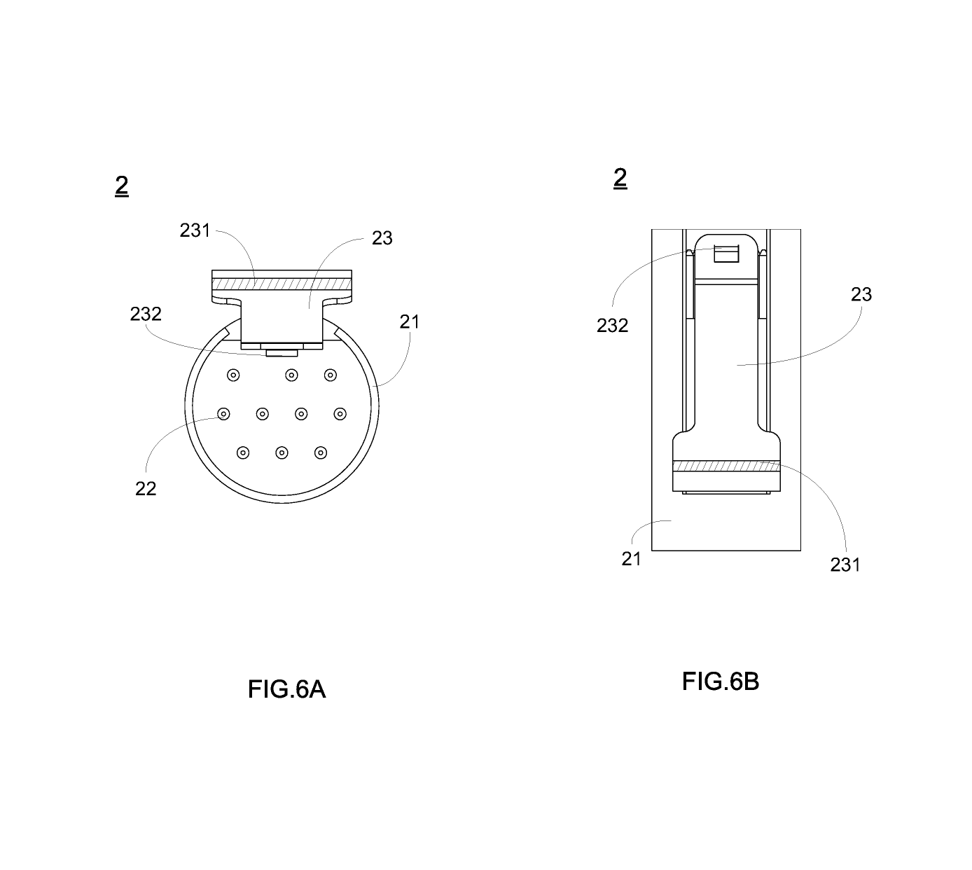

Thus, the above descriptions have been completely introduced the constituting elements of the electrical connector. Furthermore, please refer to FIG. 6A and FIG. 6B, there are shown a front view and a vertical view of the electrical plug according to the present invention, respectively. As shown in FIG. 6A and FIG. 6B, the electrical plug 2 is able to be plugged into the first accommodating portion 112 of the electrical connector 1 for assembly, wherein the electrical plug 2 includes: a plug main body 21, a plurality of second terminals 22, and a locking mechanism 23. The plurality of second terminals 22 pass through the plug main body 21. The locking mechanism 23 is deposed on one side of the plug main body 21 and has a pressing portion 231 and a second pocking portion 232.

As shown in FIG. 2, FIG. 3C, FIG. 4, FIG. 6A, and FIG. 6B, each of the second terminal 22 inserted into the tunnels 1151 contacts with the two tongue plates 133 when the electrical plug 2 is assembled with the electrical connector 1; In addition, One end of each of the tunnels 1151 are chamfered and capable of guiding the second terminals to enter the tunnels 1151. The pressing portion 231 has a rough surface for providing a well pressing.

The present invention is a kind of the DIN connector, thus, the tunnels 1151, the first terminals 13, the second terminals 22 are arranged in accordance with German Institute for Standardization (Deutsches Institut Normung).

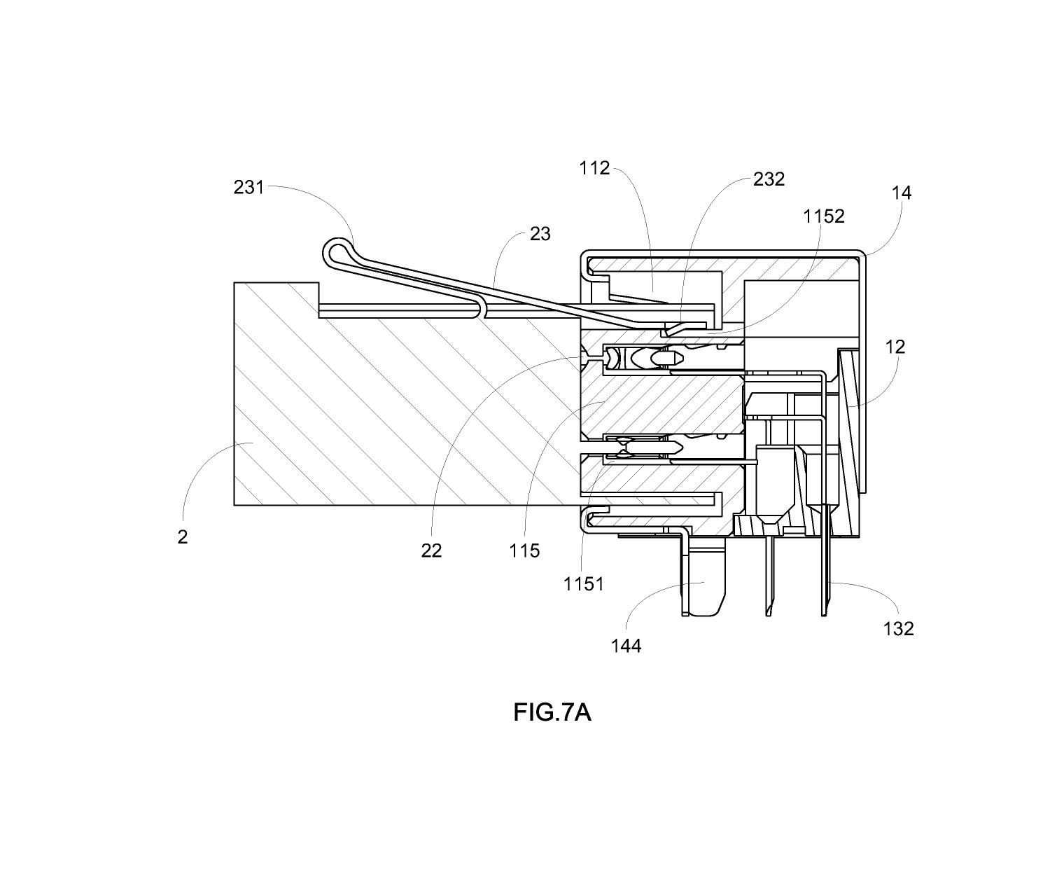

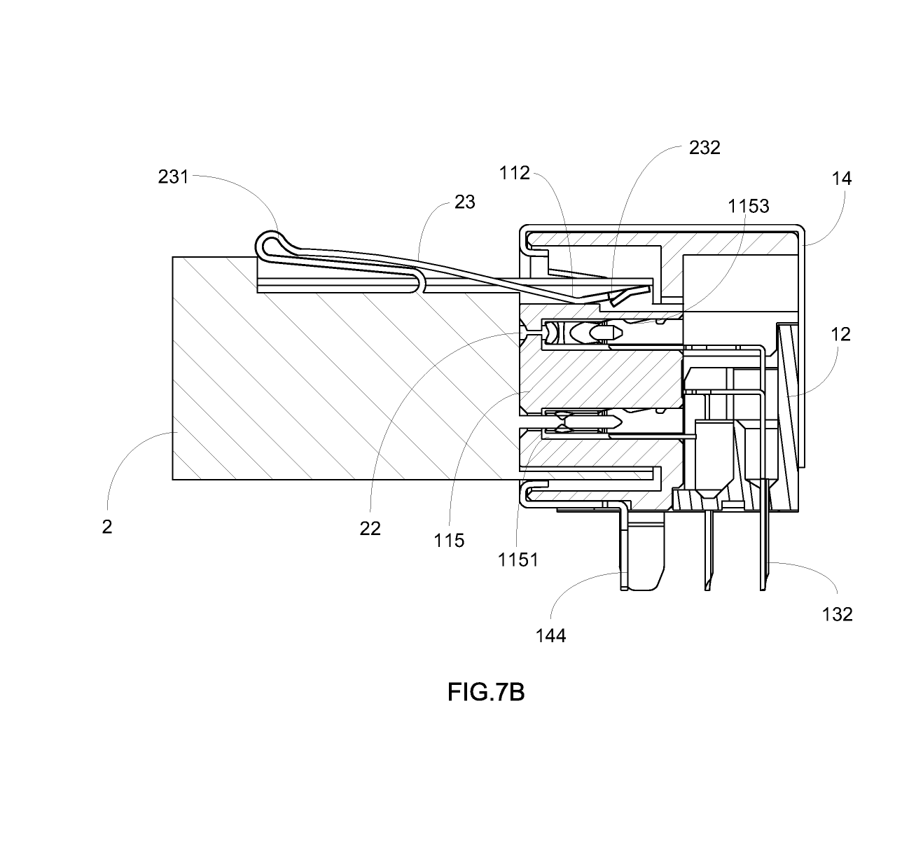

The follow up introduction is a practical embodiment for the present invention, please refer to FIG. 7A, which illustrates a lateral cross sectional view of assembling diagrams of the electrical connector and the electrical plug according to the present invention. As shown in FIG. 7A, when the electrical plug 2 is assembled with the electrical connector 1, the locking mechanism 23 enters the first accommodating portion 112 and locates on the side surface of the terminal covering body 115, meanwhile, the second locking portion 232 of the locking mechanism 23 is locked with the first locking portion 1152 on the side surface of the terminal covering body 115, and then the electrical plug 2 is connected steadily and electrically with the electrical connector 1.

Moreover, please refer to FIG. 7B, which illustrates a lateral cross sectional view of assembling diagrams of the electrical connector and the electrical plug according to the present invention. When a force is applied to the pressing portion 231, the second locking portion 232 of the locking mechanism 23 disconnects from the first locking portion 1152 on the side of the terminal covering body 115, and then the electrical plug 2 can be removed from the electrical connector 1 easily.

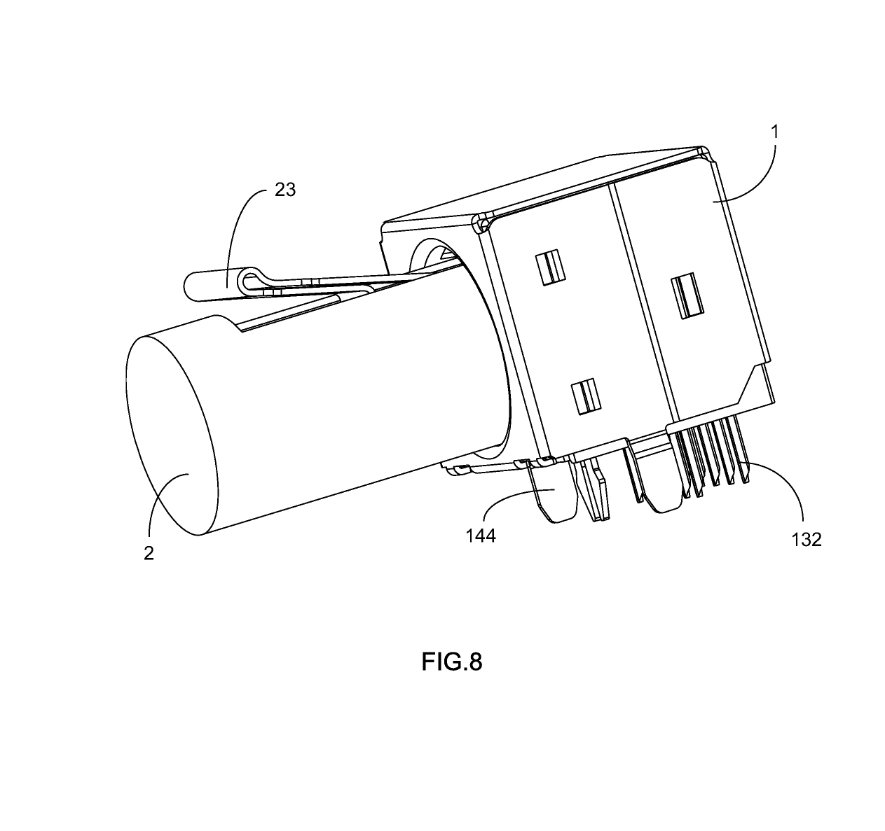

Please refer to FIG. 8, there is shown a stereo view of the electrical connector assembly with locking mechanism according to the present invention. When the electrical plug 2 is connected with electrical connector 1, the pressing mechanism 23 is at one side of the electrical plug 2 for pressing. The second ends 132 protrude from one side of the electrical connector 1 for being plugged or inserted with printed circuit board electrically. The plugging members 144 are configured to plug into holes of an external printed circuit board.

Thus, through above descriptions, it knows that how to get another practical embodiment for the electrical connector assembly with locking mechanism according to the present invention. However, the embodiments are not intended to limit scope of the present invention. The another practical embodiment of the electrical connector assembly with locking mechanism can be provided easily by changing the structure of the first locking portion 1152 and the second locking portion 232. As shown in FIG. 7A, in the practical embodiment of the electrical connector assembly with locking mechanism, the first locking portion 1152 is a slot, then the second locking portion 232 is correspondingly fabricated to a protruding block, so that the second locking portion 232 may be embedded into the first locking portion 1152 for locking. In another practical embodiment, the first locking portion may be a protruding block, then the second locking portion is correspondingly fabricated to a slot, so that the first locking portion can be embedded into the second locking portion for locking.

Therefore, the above descriptions have been clearly and completely introduced the electrical connector assembly with locking mechanism of the present invention; in summary, the present invention has the following advantages:
1. Avoiding break away easily: In the present invention, the second locking portion of the locking mechanism is locked with the first locking portion on the side surface of the terminal covering body, and then the electrical plug is steadily connected with the electrical connector. The electrical plug is connected steadily with the electrical connector according to the present invention unless the pressing portion is suffered from a force. Therefore, the present invention can avoid to break away easily, when comparing with the conventional electrical connector assembly.
2. Avoiding poor contact: In the present invention, the first end of the first terminals has the two tongue plates. When the second terminals was inserted into the tunnels, the two tongue plates of the first terminals clamp the second terminals, so that the electrical plug is connected electrically with the electrical connector, and the poor contact between the first terminal and the second terminals can be avoided.

The above description is made on embodiments of the present invention. However, the embodiments are not intended to limit scope of the present invention, and all equivalent implementations or alterations within the spirit of the present invention still fall within the scope of the present invention.

We claim:

1. An electrical connector assembly with locking mechanism, comprising:
an electrical connector, comprising:
a connector main body, having a first surface with a first accommodating portion and a second surface with a second accommodating portion, and a terminal covering body being extendedly disposed on the bottom of the first accommodating portion, wherein the terminal covering body has a plurality of tunnels and a first locking portion formed on the side surface thereof;
a housing, being able to be plugged into the second accommodating portion for combining with the connector main body;
a plurality of first terminals, wherein each first terminal having a first end with two tongue plates and a second end, and all the first ends passing through the plurality of tunnels respectively; moreover, the second end passing through the housing and protruding from one side of the housing for plugging into an external printed circuit board; and
a cover, being configured to cover the connector main body and the housing; and
an electrical plug, being plugged into the first accommodating portion of the electrical connector for assembling with the electrical connector, the electrical plug comprising:
a plug main body;
a plurality of second terminals, passing through the plug main body; and
a locking mechanism, being deposed on one side of the plug main body, and having a pressing portion and a second locking portion;
wherein when the electrical plug is assembled with the electrical connector, the locking mechanism entering the first accommodating portion and locating on the side surface of the terminal covering body, meanwhile, the second locking portion of the locking mechanism being locked with the first locking portion on the side surface of the terminal covering body, and then the electrical plug is connected steadily with the electrical connector;
wherein when the electrical plug is assembled with the electrical connector, the second terminals entering into the tunnels respectively, and contacting with the two tongue plates of the first terminals, such that the electrical plug is electrically connected with the electrical connector;
wherein when a force is applied to the pressing portion, the second locking portion of the locking mechanism disconnecting from the first locking portion on the side of the terminal covering body, and then the electrical plug can be removed from the first accommodating portion easily.

2. The electrical connector assembly with locking mechanism of claim 1, wherein the connector main body is made by a dielectric material and further comprises:
a plurality of first grooves, being formed on the two side surfaces of the connector main body;
a plurality of second grooves, being formed on the top surface and the bottom surface of the connector main body;
a second accommodating portion opening, being formed on one side of the second accommodating portion; and
two first protruding blocks, being formed on the two opposite inner surfaces of the second accommodating portion, respectively.

3. The electrical connector assembly with locking mechanism of claim 1, wherein the first locking portion is selected from the group consisting of: a slot and a protruding block.

4. The electrical connector assembly with locking mechanism of claim 3, wherein when the first locking portion is the slot, then the second locking portion is correspondingly fabricated to a protruding block, so that the second locking portion may be embedded into the first locking portion for locking.

5. The electrical connector assembly with locking mechanism of claim 3, wherein when the first locking portion is the protruding block, then the second locking portion is correspondingly fabricated to a slot, so that the first locking portion may be embedded into the second locking portion for locking.

6. The electrical connector assembly with locking mechanism of claim 2, wherein the housing is made by a dielectric material and has two second protruding blocks formed on two opposite outer sides thereof, moreover, when the housing is inserted into the second accommodating portion through the second accommodating portion opening, the two first protruding blocks being engaged with the two second protruding blocks for steadily connecting the housing with the connector main body.

7. The electrical connector assembly with locking mechanism of claim 1, wherein the plurality of first terminals is made by an electric material.

8. The electrical connector assembly with locking mechanism of claim 1, wherein the two tongue plates have a bending respectively, and the two tongue plates being contacted with the second terminals when the second terminals are inserted into the tunnels.

9. The electrical connector assembly with locking mechanism of claim 1, wherein the cover is made by an electric material, and further comprises:
a cover main body;
a plurality of positioning members, being formed on the two opposite sides of the cover main body;
a cover opening, being formed at the front surface of the cover main body; and
at least one plugging member, being configured to plug into a hole of an external printed circuit board;
wherein when the cover is covered on the connector main body, the plurality of positioning members being positioned inside the plurality of first grooves respectively;
wherein when the cover is covered on the connector main body, the coveropening being corresponding to the first surface.

10. The electrical connector assembly with locking mechanism of claim 1, wherein the pressing portion has a rough surface.

11. The electrical connector assembly with locking mechanism of claim 1, wherein the plurality of tunnels, the plurality of first terminals, and the plurality of second terminals are arranged in accordance with German Institute for Standardization.
